(19) United States
(12) Patent Application Publication
(10) Pub. No.: US 2025/0091926 A1
(43) Pub. Date: Mar. 20, 2025

(54) DEVICES AND METHODS FOR CONTROLLING EXTRACTION AMOUNTS AND HOMOGENIZING GLASS LIQUID

(71) Applicant: CAIHONG DISPLAY DEVICES CO., LTD., Xianyang, (CN)

(72) Inventors: Chao YU, Xianyang (CN); Guohong YANG, Xianyang (CN); Wei YANG, Xianyang (CN)

(73) Assignee: CAIHONG DISPLAY DEVICES CO., LTD., Xianyang, Shaanxi (CN)

(21) Appl. No.: 18/970,819

(22) Filed: Dec. 5, 2024

Related U.S. Application Data
(63) Continuation-in-part of application No. PCT/CN2024/092910, filed on May 13, 2024.

(30) Foreign Application Priority Data
Jun. 19, 2023 (CN) 202310728595.1

(51) Int. Cl. C03B 7/00; C03B 7/07

(52) U.S. Cl. CPC C03B 7/005; C03B 7/07

(57) ABSTRACT

Embodiments of the present disclosure provide a device and method for controlling an extraction amount and homogenizing glass liquid, comprising a feeding device and an auxiliary heating device. The feeding device includes a feeding inner pipe and a feeding outer pipe, the feeding inner pipe being provided inside the feeding outer pipe. The feeding outer pipe includes a feeding upper outer pipe, a feeding middle outer pipe, a feeding lower outer pipe, and a tapered pipe, the feeding upper outer pipe being mounted at an upper end of the feeding middle outer pipe, the feeding lower outer pipe being installed at a lower end of the feeding middle outer pipe, and the feeding upper outer pipe, the feeding middle outer pipe, and the feeding lower outer pipe being connected through the tapered pipe, and the auxiliary heating device includes an inner heater and an outer heater.

### CROSS-REFERENCE TO RELATED APPLICATIONS

The present disclosure is a continuation in part of international application No. PCT/CN2024/092910, filed on May 13, 2024, which claims priority to Chinese Patent Application No. 202310728595.1, filed on Jun. 19, 2023, the entire contents of each of which are incorporated herein by reference.

### TECHNICAL FIELD

The present disclosure relates to the field of substrate glass manufacturing, and in particular, to a device and method for controlling an extraction amount and homogenizing glass liquid.

### BACKGROUND

Substrate glass is one of the essential raw materials for manufacturing liquid crystal panels and has a significant impact on panel performance. Key metrics of finished panels, such as a resolution, a light transmittance, a thickness, a weight, and a viewing angle, are all closely related to the quality of the substrate glass that is used for manufacturing the finished panels.

The production process of substrate glass involves melting the batch materials in a tank furnace to form glass liquid. The glass liquid undergoes heating, refining, and cooling with stirring in a platinum channel, such that the temperature of high temperature glass liquid meets a condition required for forming and feeding. A feeding device is one of key devices in a substrate glass manufacturing process. A primary function of the feeding device is to stably and uniformly deliver glass liquid for forming, achieving a high-quality overflow down-draw process.

Due to the fluctuations in the temperature of the incoming glass liquid and the need for stable control of the extraction amount, the feeding device must continuously heat the glass liquid to maintain a required feeding temperature and a stable extraction amount. However, in a current feeding device, the heating on one side by the heater leads to uneven temperature distribution between the inside and outside of the glass liquid, and also increase the response time of the glass liquid to temperature changes. This makes it impossible to achieve rapid response and precise control of the extraction amount, which in turn affects the quality of the overflow down-draw process, resulting in defects such as uneven substrate glass thickness, unfulfilled stress requirements, and warping issues.

### SUMMARY

The present disclosure provides a device and method for controlling an extraction amount and homogenizing glass liquid with an aim to solve the issues of substrate glass defects caused by uneven temperature distribution within the glass liquid and to achieve rapid response and precise control of the extraction amount.

In order to achieve the above purpose, the present disclosure adopts the following technical solution:

One of the embodiments of the present disclosure provides a device for controlling an extraction amount and homogenizing glass liquid, comprising a feeding device and an auxiliary heating device. The feeding device may include a feeding inner pipe and a feeding outer pipe, the feeding inner pipe being set inside the feeding outer pipe. The feeding outer pipe may include a feeding upper outer pipe, a feeding middle outer pipe, a feeding lower outer pipe, and a tapered pipe, the feeding upper outer pipe being mounted at an upper end of the feeding middle outer pipe, the feed lower outer pipe being mounted at a lower end of the feeding middle outer pipe, and the feeding upper outer pipe, the feeding middle outer pipe, and the feeding lower outer pipe being connected through the tapered pipe. The auxiliary heating device may include an inner heater and an outer heater, the inner heater is provided inside the feeding inner pipe and is mounted by fitting with the feeding inner pipe, and the outer heater wraps the feeding outer pipe and is mounted by fitting with the feeding outer pipe.

One of the embodiments of the present disclosure provides a method for controlling an extraction amount and homogenizing glass liquid, comprising: in response to receiving an instruction from a molding process to decrease or increase an extraction amount, adjusting currents of an inner heater and an outer heater, and controlling a temperature according to the currents to ensure a precise control of the extraction amount of the glass liquid and a homogenization of a temperature of the glass liquid after the extraction amount has been adjusted; in response to receiving the instruction from the molding process to decrease the extraction amount, decreasing the currents of the inner heater and the outer heater. The temperature of the glass liquid is controlled to be decreased by decreasing the currents; and in response to receiving the instruction from the molding process to increase the extraction amount, increasing the currents of the inner heater and the outer heater. The temperature of the glass liquid is controlled to be increased by increasing the currents.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, where:

FIG. 1 is a schematic diagram illustrating a longitudinal cross-sectional view of a device for controlling an extraction amount and homogenizing glass liquid according to some embodiments of the present disclosure;

FIG. 2 is a schematic diagram illustrating an axial cross-sectional view of a device for controlling an extraction amount and homogenizing glass liquid according to some embodiments of the present disclosure;

FIG. 3 is a schematic diagram illustrating a partially enlarged view of a longitudinal cross-sectional view of a device for controlling an extraction amount and homogenizing glass liquid according to some embodiments of the present disclosure;

FIG. 4 is a schematic diagram illustrating a feeding device according to some embodiments of the present disclosure;

FIG. 5 is a schematic diagram illustrating a partially enlarged view of a longitudinal cross-sectional view of a device for controlling an extraction amount and homogenizing glass liquid with a downward-sloping bump according to some embodiments of the present disclosure;

FIG. 6 is a flowchart illustrating a process for controlling an extraction amount and homogenizing glass liquid according to some embodiments of the present disclosure;

FIG. 7 is a schematic diagram illustrating a distribution prediction model according to some embodiments of the present disclosure; and

FIG. 8 is a schematic diagram illustrating an energy prediction model according to some embodiments of the present disclosure.

Reference Numbers: 1: a feeding device; 2: an auxiliary heating device; 3: a feeding inner pipe; 4: a feeding outer pipe; 4-1: a feeding upper outer pipe; 4-2: a feeding middle outer pipe; 4-3: a feeding lower outer pipe; 4-4: a tapered pipe; 5: a feeding space; 6: an inner heater; 7: an inner filling gap; 8: an outer heater; 9: an outer filling gap; 10: an insulation material; 12: a downward-sloping bump.

### DETAILED DESCRIPTION

In order to more clearly illustrate the technical solutions of the embodiments of the present disclosure, a brief description of the accompanying drawings required to be used in the description of the embodiments is given below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit,” and/or “module” as used herein is a way to distinguish between different components, elements, parts, sections, or assemblies at different levels. However, other expressions may replace words if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including,” and “comprising” suggest only the inclusion of clearly identified steps and elements that do not constitute an exclusive list, and the method or apparatus may also include other steps or elements.

Flowcharts are used in the present disclosure to illustrate operations performed by a system according to embodiments of the present disclosure. It should be appreciated that the preceding or following operations are not necessarily performed in an exact sequence. Instead, steps can be processed in reverse order or simultaneously. Also, it is possible to add other operations to these processes or to remove a step or steps from these processes.

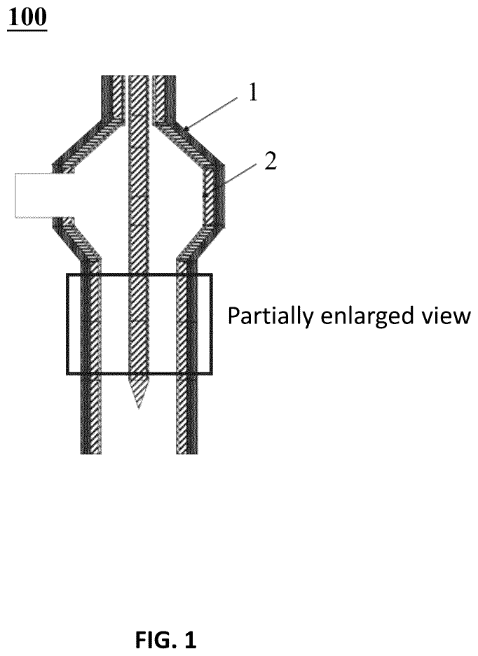

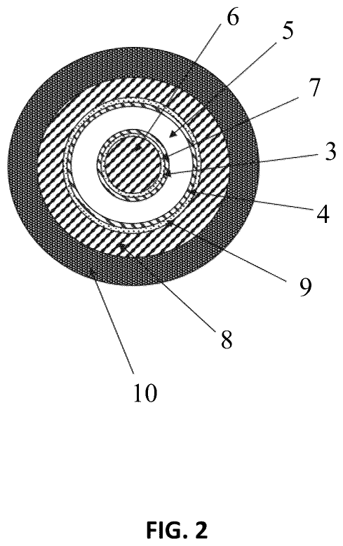

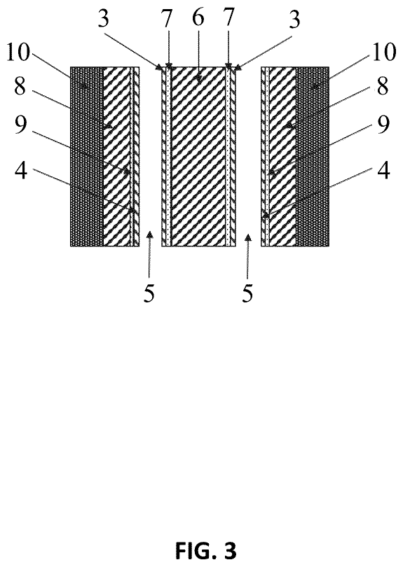

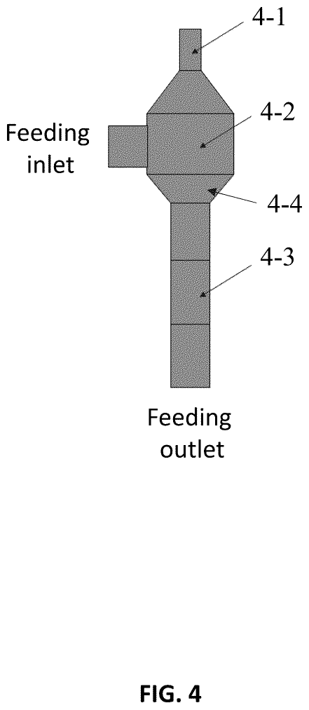

FIG. 1 is a partially enlarged view of a longitudinal sectional view of an extraction amount control and glass liquid homogenization device shown according to some embodiments of the present disclosure. FIG. 2 is an axial cross-sectional view of a lead-out volume control and glass liquid homogenizing device according to some embodiments of the present disclosure. FIG. 3 is a longitudinal cross-sectional view of a lead-out volume control and vitreous liquid homogenization device according to some embodiments of the present disclosure. FIG. 4 is a schematic view of a feeding device according to some embodiments of the present disclosure.

In some embodiments, as shown in FIG. 1, a device 100 for controlling an extraction amount and homogenizing glass liquid includes a feeding device 1 and an auxiliary heating device 2.

The feeding device 1 refers to a device for steadily and uniformly supplying molten glass liquid to a molding process. In some embodiments, the feeding device 1 is made of a platinum-rhodium alloy. The feeding device 1 referred to as a platinum-rhodium alloy feeding device or a platinum feeding device.

In some embodiments, as shown in FIG. 1 to FIG. 4, the feeding device 1 includes a feeding inner pipe 3 and a feeding outer pipe 4. The feeding inner pipe 3 is provided inside the feeding outer pipe 4, and the feeding outer pipe includes a feeding upper outer pipe 4-1, a feeding middle outer pipe 4-2, a feeding lower outer pipe 4-3, and a tapered pipe 4-4. The feeding upper outer pipe 4-1 is mounted at an upper end of the feeding middle outer pipe 4-2. The feeding lower outer pipe 4-3 is mounted at a lower end of the feeding middle outer pipe 4-2. The feeding upper outer pipe 4-1, the feeding middle outer pipe 4-2, and the feeding lower outer pipe 4-3 are connected through the tapered pipe 4-4.

The feeding inner pipe 3 is an internal pipe for transferring or supplying a material. In some embodiments, the feeding inner pipe is a circular straight pipe with a diameter within a range of 130 mm to 150 mm. For example, the diameter of the feeding inner pipe is 130 mm, 140 mm, 150 mm, or the like.

The feeding outer pipe 4 is an external pipe for transferring or holding a material for a feeding process. The feeding outer pipe 4 includes a feeding upper outer pipe, a feeding middle outer pipe, and a feeding lower outer pipe. In some embodiments, the feeding outer pipe is a tapered pipe.

The tapered pipe 4-4 is a round straight pipe with different diameters.

In some embodiments, the feeding inner pipe 3 includes a circular straight pipe and a conical pipe, and the conical pipe is mounted at an end of the circular straight pipe of the feeding inner pipe 3.

In some embodiments of the present disclosure, the feeding inner pipe 3 includes the circular straight pipe and the conical pipe, which can effectively reduce a flow resistance, reduce a temperature gradient, and optimize a distribution of a flow field, so as to ensure a smooth flow of the glass liquid and a homogenization of a temperature of the glass liquid, thereby improving the quality of the glass liquid.

In some embodiments, the feeding inner pipe 3 and the feeding outer pipe 4 are made of a platinum-rhodium alloy.

In some embodiments, a wall thicknesses of the feeding inner pipe 3 and a wall thickness of the feeding outer pipe 4 are at least within a range of 0.8 mm to 1.2 mm. For example, each of the wall thicknesses of the feeding inner pipe 3 and the feeding outer pipe 4 is 0.8 mm, 1.0 mm, 1.2 mm, or the like. Materials of the feeding inner pipe and the feeding route pipe are all platinum-rhodium alloy, and a rhodium mass percentage thereof is greater than or equal to 5%.

In some embodiments of the present disclosure, the feeding inner pipe 3 and the feeding outer pipe 4 are made of platinum-rhodium alloy, which has an excellent high-temperature resistance, an oxidation resistance, and a chemical stability, thereby ensuring a long-term stable operation of the feeding device 1, and preventing oxides from being generated in a high-temperature environment, henceforth ensuring the quality of the glass liquid.

In some embodiments of the present disclosure, by designing a length of the feeding inner pipe 3 less than a length of the feeding outer pipe 4, it is possible to converge the glass liquid in a feeding space 5 at an outlet of the feeding device 1, which addresses the issues of substrate glass defects caused by an uneven temperature distribution between an inner layer and an outer layer of the glass liquid and enables a rapid response and precise control of the extraction amount.

The feeding upper outer pipe 4-1 is located at an upper end of the feeding outer pipe 4.

The feeding middle outer pipe 4-2 is located in a middle of the feeding outer pipe 5 and is configured to connect the feeding upper outer pipe 4-1 and the feeding lower outer pipe 4-3.

The feeding lower outer pipe 4-3 is a pipe located at a lower end of the feeding outer pipe 4 and is configured to connect the feeding middle outer pipe 4-2.

In some embodiments, each of the feeding upper outer pipe 4-1, the feeding middle outer pipe 4-2, and the feeding lower outer pipe 4-3 is a circular straight pipe with a shape of a hollow cylinder, and a shape of the tapered pipe 4-4 is a hollow frustum of a conc.

In some embodiments of the present disclosure, by adopting a structure of a circular straight pipe with a shape of a hollow cylinder, it is easy to manufacture and mount. At the same time, the smooth flow of the glass liquid is ensured, a flow resistance is reduced, and homogenized transfer of heat is facilitated, thereby ensuring the homogenization of the temperature of the glass liquid.

In some embodiments, a cross-sectional diameter of the feeding middle outer pipe 4-2 is larger than a cross-sectional diameter of the feeding lower outer pipe 4-3, and the cross-sectional diameter of the feeding lower outer pipe 4-3 is larger than a cross-sectional diameter of the feeding upper outer pipe 4-1. The cross-sectional diameter of the feeding upper outer pipe 4-1 refers to a transverse diameter of the feeding upper outer pipe 4-1 in a direction perpendicular to a flow direction of the glass liquid in a longitudinal sectional view. The cross-sectional diameter of the feeding middle outer pipe 4-2, and the cross-sectional diameter of the feeding lower outer pipe 4-3 are similar to the cross-sectional diameter of the feeding upper outer pipe 4-1, and will not be repeated here.

In some embodiments, a length of the feeding middle outer pipe 4-2 is greater than a length of the feeding lower outer pipe 4-3, and the length of the feeding lower outer pipe 4-3 is greater than a length of the feeding upper outer pipe 4-1. The length of the feeding upper outer pipe 4-1 refers to a longitudinal length of the feeding upper outer pipe 4-1 in the flow direction of the glass liquid in the longitudinal sectional view. The length of the feeding middle outer pipe 4-2 and the length of the feeding lower outer pipe 4-3 are similar to the length of the feeding upper outer pipe 4-1, and will not be repeated herein.

For example, the cross-sectional diameter of the feeding upper outer pipe 4-1 is at least within a range of 150 mm to 170 mm. For example, the cross-sectional diameter of the feeding upper outer pipe 4-1 is 150 mm, 160 mm, 170 mm, or the like. The length of the feeding upper outer pipe 4-1 is at least within a range of 300 mm to 400 mm. For example, the length of the feeding upper outer pipe is 300 mm, 350 mm, 400 mm, or the like.

Exemplarily, the cross-section diameter of the feeding middle outer pipe 4-2 is at least within a range of 300 mm to 340 mm, for example, the cross-section diameter of the feeding middle outer pipe 4-2 is 300 mm, 320 mm, 340 mm, or the like. The length of the feeding middle outer pipe 4-2 is at least within a range of 300 mm to 350 mm, for example, the length of the feeding middle outer pipe 4-2 is 300 mm, 325 mm, 350 mm, and the like.

Exemplarily, the cross-sectional diameter of the feeding lower outer pipe 4-3 is at least within a range of 190 mm to 230 mm. For example, the cross-sectional diameter of the feeding lower outer pipe 4-3 is 190 mm, 210 mm, 230 mm, or the like. The length of the feeding lower outer pipe 4-3 is at least within a range of 900 mm to 1000 mm. For example, the length of the feeding lower outer 4-3 pipe is 90 mm, 95 mm, 100 mm, or the like.

In some embodiments of the present disclosure, the cross-sectional diameter of the feeding middle outer pipe 4-2 is the largest, and the feeding middle outer pipe 42 is located at a middle position, which can effectively buffer the impact of the flow of the glass liquid and reduce turbulence. At the same, since the length of the feeding middle outer pipe 4-2 is the largest, it ensures that the glass liquid stays for a long period, which is favorable for a homogenized distribution of the temperature of the glass liquid. Dimensions of the feeding lower outer pipe 4-3 and the feeding upper outer pipe 4-3 are gradually reduced, which can ensure that a flow rate of the glass liquid is gradually reduced, and avoid impact and splashing at an outlet of the feeding device.

The auxiliary heating device 2 refers to a device for heating the glass liquid. The auxiliary heating device 2 ensures a temperature of a feeding material, stabilizes an extraction amount, and realizes a quick response and precise control of adjustment of the extraction amount. In some embodiments, as shown in FIGS. 1 to 4, the auxiliary heating device 2 includes an inner heater 6 and an outer heater 8. The inner heater 6 is disposed inside the feeding inner pipe 3 and is mounted by fitting with the feeding inner pipe 3, and the outer heater 8 wraps the feeding outer pipe 4 and is mounted by fitting with the feeding outer pipe 4.

In some embodiments, the auxiliary heating device 2 is divided into 5 to 10 groups from top to bottom, with each group including an inner heater 6 and an outer heater 8. The outer heater 8 is of a same shape as the feeding outer pipe 4 and is mounted by fitting in conjunction with the feeding outer pipe 4. The inner heater 6 is cylindrical-shaped.

The inner heater 6 is a device that heats the glass liquid to increase an internal temperature of the glass liquid. The outer heater 8 refers to a device that heats the feeding outer pipe 4 to increase an external temperature of the glass liquid. The inner heater 6 and the outer heater 8 are provided inside the auxiliary heating device 2 for providing heat.

In some embodiments, the outer heater 8 is wrapped with an insulation material 10 outside. For example, a thickness of the insulation material 10 is at least within a range of 50 mm to 150 mm. For example, the thickness of the insulation material 10 is 50 mm, 75 mm, 100 mm, 125 mm, 150 mm, or the like.

In some embodiments, the insulation material 10, the inner heater 6, and the outer heater 8 are made of aluminum oxide.

The aluminum oxide refers to a substance that can form a dense and stable oxide protective layer in high-temperature oxidizing environments. For example, the aluminum material is nickel-based superalloy. A thermal conductivity of the aluminum oxide is less than or equal to 3 kcal/(m.h. ° C.).

In some embodiments of the present disclosure, by wrapping the insulation material 10 around the outside of the outer heater 8, the heat dissipation is effectively reduced and the thermal efficiency is improved, thereby ensuring the stabilization of a temperature of the glass liquid during an extraction process.

In some embodiments of the present disclosure, the insulation material 10, the inner heater 6, and the outer heater 8 made of aluminum oxide utilize high-thermal-conductivity and high-temperature-resistant properties of the alumina oxide, which further enhances the heating efficiency and durability of the device while maintaining the homogenization of the temperature of the glass liquid.

In some embodiments, the inner heater 6 is cylindrical-shaped. In some embodiments, the inner heater 6 and the outer heater 8 are embedded with a pure platinum wire inside, which generates heat through self-heating upon electrification. In some embodiments, a diameter of the pure platinum wire is at least within a range of 2.5 mm to 3.0 mm. For example, the diameter of the pure platinum wire is 2.5 mm, 2.6 mm, 2.7 mm, 2.8 mm, 2.9 mm, 3.0 mm, or the like.

In some embodiments of the present disclosure, the inner heater 6 is designed to be cylindrical-shaped, which helps to achieve a homogenized distribution of heat and reduce a heat concentration point, thereby improving the heating efficiency and homogenization of the glass liquid. In addition, the inner heater 6 and the outer heater 8 are embedded with the pure platinum wire inside. By leveraging a high melting point, an excellent electrical heating performance, and a chemical stability of the pure platinum wire, the heating process can be both efficient and stable. In response to setting a diameter of the pure platinum wire being within a range of 2.5 mm to 3.0 mm, it ensures sufficient electrical resistivity and thermal power output, thus ensuring heating efficiency and safety.

In some embodiments, an inner filling gap 7 is formed between the inner heater 6 and the feeding inner pipe 3, an outer filling gap 9 is formed between the outer heater 8 and the feeding outer pipe 4, and the feeding space 5 is formed between the feeding inner pipe 3 and the feeding outer pipe 4.

In some embodiments, widths of the inner filling gap 7 and the outer filling gap 9 are at least within a range of 10 mm to 20 mm. For example, the widths of the inner filling gap 7 and the outer filling gap 9 are 10 mm, 12 mm, 14 mm, 16 mm, 18 mm, 20 mm, or the like. A width of the inner filling gap 7 refers to a transverse dimension of the inner filling gap 7 in the direction perpendicular to the flow direction of the glass liquid in the longitudinal sectional view. The width of the outer filling gap 9 refers to a transverse dimension of the outer filling gap 9 in the direction perpendicular to the flow direction of the glass liquid in the longitudinal sectional view.

In some embodiments, a filling material in the inner filling gap 7 and the outer filling gap 9 is alumina powder. The alumina powder is mixed with pure water at 60° C. to 90° C. in a volume ratio of (2˜5):1 to prepare a slurry for casting. In some embodiments of the present disclosure, by forming the inner filling gap 7 between the inner heater 6 and the feeding inner pipe 3, and the outer filling gap 9 between the outer heater 8 and the feeding outer pipe 4, the efficiency of heat transfer is improved, which ensures that the heating process of the glass liquid is homogenized during a flow process.

In some embodiments of the present disclosure, controlling the widths of the inner filling gap 7 and the outer filling gap 9 to be within a range of 10 mm to 20 mm ensures that the filling material can efficiently transfer heat. At the same time, heat loss caused by excessive width is prevented or heat transfer efficiency due to overly compacted filling material in narrower gaps is reduced.

In some embodiments of the present disclosure, the use of the alumina powder as the filling material for the inner filling gap 7 and the outer filling gap 9 improves the efficiency of the heat transfer.

In some embodiments of the present disclosure, a device for controlling an extraction amount and homogenizing glass liquid is provided, the feeding device 1 and the auxiliary heating device 2 are disposed, the feeding device 1 includes the feeding inner pipe 3 and the feeding outer pipe 4, and the feeding inner pipe 3 is provided inside the feeding outer pipe 4. The auxiliary heating device 2 includes the inner heater 6 and the outer heater 8, the inner heater 6 is provided inside the feeding inner pipe 3, and the outer heater 8 is provided outside the feeding outer pipe 4. Such structure ensures the homogenization of the temperature of the glass liquid in a molding process, thereby avoiding the uneven temperature leading to defects in a substrate glass. Besides, setting the inner heater and the outer heater can realize the quick response and precise control of the adjustment of the extraction amount, thereby effectively improving production efficiency.

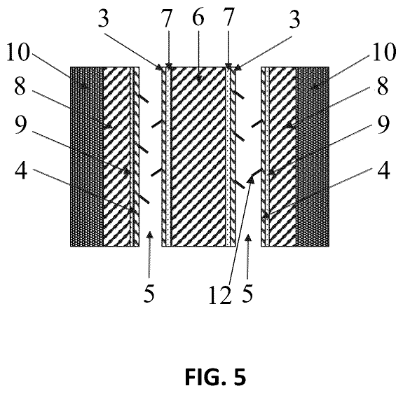

FIG. 5 is a schematic diagram illustrating a partially enlarged view of a longitudinal sectional view of a device for controlling an extraction amount and homogenizing a glass liquid with a downward-sloping bump according to some embodiments of the present disclosure.

In some embodiments, as shown in FIG. 5, a plurality of downward-sloping bumps 12 are arranged in a staggering manner on an outer side of the feeding inner pipe 3 and on an inner side of the feeding outer pipe 4.

The outer side of the feeding inner pipe 3 is a side of the feeding inner pipe 3 that is in contact with the feeding space 5. The inner side of the feeding outer pipe 4 is a side of the feeding outer pipe 4 that is in contact with the feeding space 5.

The downward-sloping bump 12 refers to a structure that influences a flow behavior of a glass liquid. For example, the downward-sloping bump 12 includes, but is not limited to, a cylinder, a rectangle, etc. By arranging the downward-sloping bump 12, it is possible to enable a glass liquid that is close to the feeding inner pipe 3 and a glass liquid that is close to the feeding outer pipe 4 in the feeding space 5 to mix with each other while flowing downward.

In some embodiments, the plurality of downward-sloping bumps 12 are arranged at a preset interval and a preset slope.

The preset interval is a vertical distance between two adjacent downward-sloping bumps in a direction where the glass liquid flows downward. The smaller the vertical distance, the more densely arranged the downward-sloping bumps 12 are, and the smaller the preset interval. For example, the preset interval is 5 mm, 10 mm, and 15 mm, which is not limited herein.

The preset slope is an angle between a first extension line and a second extension line. The first extension line starts from a starting point of the downward-sloping bump 12 along an inner wall of the feeding inner pipe 3 or the feeding outer pipe 5 to an end point of the downward-sloping bump 12. The second extension line is an extension line along a flow direction of glass liquid in the feeding inner pipe 3 or feeding outer pipe 4. For example, the preset slope is 30 degrees, 45 degrees, and 60 degrees, which is not limited herein.

In some embodiments, the preset interval and the preset slope are determined based on a rated flow rate of the glass liquid. For example, a processor selects, based on historical experimental data, a preset interval and a preset slope corresponding to an optimal intermixing effect of the glass liquid that can be achieved at different rated flow rates.

The optimal intermixing effect means that the plurality of downward-sloping bumps 12, arranged at the preset interval and the preset slope, not only ensure that the glass liquid at different rated flow rates can effectively eliminate a temperature difference during a flow process, but also ensure that the glass liquid can flow downward smoothly without obstruction.

The rated flow rate is a preset steady flow rate that the glass liquid should maintain. The rated flow rate may be set by a specialized technician or by system default.

In some embodiments of the present disclosure, determining the preset interval and the preset slope of the downward-sloping bumps 12 based on the rated flow rate of the glass liquid not only ensures that the temperature difference can be effectively eliminated when the glass liquid flows, but also ensures that the glass liquid flows smoothly without obstruction, and thereby enabling glass liquid to mix well when flowing downward.

In some embodiments, the processor determines a length of the downward-sloping bump 12 based on a dimension of the feeding space 5.

The dimension of the feeding space 5 is a three-dimensional dimension of a space formed between the feeding inner pipe 3 and the feeding outer pipe 4. In some embodiments, the dimension of the feeding space 5 is obtained by experimental measurement.

The length of the downward-sloping bump 12 is a straight line distance between a starting point of the inner wall of the feeding inner pipe 3 or the feeding outer pipe 5 and an end point of the downward-sloping bump 12.

In some embodiments, the processor selects a length that enables the optimal intermixing effect to be achieved as the length of the downward-sloping bump 12 based on the historical experimental data and dimensions of different feeding spaces 5.

In some embodiments, determining the length of the downward-sloping bump 12 further includes ensuring that the length satisfies a preset structural condition.

The preset structural condition is that a vertical flow space exists within the feeding space 5.

The vertical flow space is a space within the feeding space 5 that allows the glass liquid to directly flow unobstructed (e.g., without passing through the downward-sloping bump 12) downwardly and vertically.

In some embodiments, the processor determines the vertical flow space based on the dimension of the feeding space 5 and the length of the downward-sloping bump 12. For example, the processor determines the vertical flow space based on experimental simulation calculations.

In some embodiments of the present disclosure, in response to determining the length of the downward-sloping bump 12 being excessively long, a normal downward flow of the glass liquid is impeded, resulting in blockage. Thus, by ensuring that the length of the downward-sloping bump 12 satisfies the preset structural condition, it is possible to efficiently prevent the blockage of the feeding space 5 by impurities or unused material in the glass liquid.

In some embodiments of the present disclosure, determining the length of the downward-sloping bump 12 based on the dimension of the feeding space 5 is conducive to mixing the glass liquid, thereby improving a homogenization of the glass liquid, and ensuring that the glass liquid has a well homogenized temperature and composition.

In some embodiments of the present disclosure, there is a little temperature difference between glass liquid that is close to the feeding inner pipe 3 and glass liquid that is close to the feeding outer pipe 4. Therefore, arranging the downward-sloping bumps 12 is conducive to mixing the glass liquid in the feeding space 5, which promotes the homogenization of the temperature of the glass liquid, thereby eliminating the temperature difference.

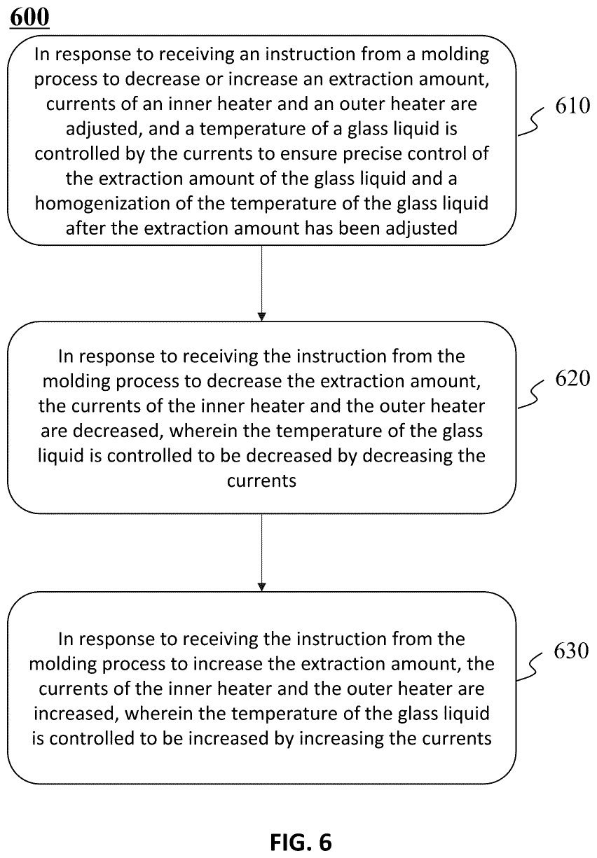

FIG. 6 is a flowchart illustrating a process for controlling an extraction amount and homogenizing a glass liquid according to some embodiments of the present disclosure. As shown in FIG. 6, a process 600 includes following operations. In some embodiments, the process 600 is performed by a processor in a device for controlling an extraction amount and homogenizing a glass liquid.

In some embodiments, the processor is a portion of the device for controlling an extraction amount and homogenizing a glass liquid configured to proceed information and/or data related to the device for controlling an extraction amount and homogenizing a glass liquid to perform one or more functions described in the embodiments of the present disclosure. In some embodiments, the processor is a device that is independent of the device for controlling an extraction amount and homogenizing a glass liquid and is configured to control an extraction amount and homogenize a glass liquid.

In some embodiments, the processor includes one or more processing engines (e.g., a single-chip processing engine or a multi-chip processing engine). By way of example only, the processor includes a central processing unit (CPU), an application-specific integrated circuit (ASIC), etc., or any combination of the above.

In some embodiments, in response to receiving an instruction from a molding process to decrease or increase the extraction amount, currents of an inner heater and an outer heater are adjusted, and a temperature of the glass liquid is controlled by the currents to ensure a precise control of the extraction amount of the glass liquid and a homogenization of a temperature of the glass liquid after the extraction amount has been adjusted. In response to receiving the instruction from the molding process to decrease the extraction amount, the currents of the inner heater and the outer heater are decreased. The temperature of the glass liquid is controlled to be decreased by decreasing the currents. In response to receiving the instruction from the molding process to increase the extraction amount, the currents of the inner heater and the outer heater are increased. The temperature of the glass liquid is controlled to be increased by increasing the currents.

Operation 610, in response to receiving the instruction from the molding process to decrease or increase the extraction amount, the currents of the inner heater and the outer heater are adjusted, and the temperature of the glass liquid is controlled by the currents to ensure precise control of the extraction amount of the glass liquid and the homogenization of the temperature of the glass liquid after the extraction amount has been adjusted.

The molding process is a stage in a glass manufacturing process. In the molding process, the glass liquid is guided into a mold where it is cooled and cured to form a desired shape.

The extraction amount is an amount of glass liquid that flows out, which may be obtained by measurement of a flow meter. In some embodiments, the flow meter is deployed on a pipe wall where a feeding space is in contact with a feeding outer pipe or a feeding inner pipe.

The instruction to increase or decrease the extraction amount is an instruction configured to indicate that the device for controlling an extraction amount and homogenizing glass liquid needs to increase or decrease an amount of glass liquid that flows out.

In some embodiments, the processor, in response to receiving the instruction from the molding process to increase or decrease the extraction amount, current adjustment amounts of the inner heater and the outer heater may be estimated based on experience of operators and historical experimental data.

In some embodiments, in response to determining that a change amount of the extraction amount of the glass liquid in a preset interval satisfies a current adjustment condition, a target temperature of the glass liquid is determined based on a current temperature of the glass liquid and a change feature of the glass liquid of the molding process.

The preset interval is a preset time period that may be set by a specialized technician or by system default.

The change amount is an increase amount or a decrease amount of the extraction amount of the glass liquid in the preset interval.

The current adjustment condition is a condition configured to determine whether to adjust a current. In some embodiments, the current adjustment condition includes the change amount of the extraction amount of the glass liquid in the preset interval being greater than a preset threshold.

The preset threshold is a threshold used to determine if the change amount is too large, and may be set by a technical professional or by system default.

The change feature is the increase amount or the decrease amount of the extraction amount of the glass liquid in the molding process.

The current temperature is an actual temperature of the glass liquid, which may be obtained by a temperature sensor. In some embodiments, the temperature sensor is deployed on a wall where the feeding space is in contact with the feeding outer pipe or the feeding inner pipe. The target temperature is a desired temperature of the glass liquid.

In some embodiments, the processor determines the target temperature of the glass liquid based on the current temperature of the glass liquid and the change feature of the glass liquid of the molding process through a first preset relationship table.

In some embodiments, the first preset relationship table includes a correspondence between the current temperature of the glass liquid, the change feature of the glass liquid of the molding process, and the target temperature of the glass liquid. In some embodiments, the first preset relationship table is determined based on current temperatures of a glass liquid, change features of a glass liquid of a molding process, and actual target temperatures in historical experimental data. The actual target temperatures may be determined based on a priori experience.

In some embodiments, the processor determines a power adjustment amount based on a current heating power, the current temperature, and the target temperature.

The heating power is a total power of the inner heater and the outer heater to perform heating.

In some embodiments, the processor designates a total heating power, which is calculated based on a current current of the inner heater and a current current of the outer heater, as the heating power.

The power adjustment amount is a value of an adjusted power. For example, the power adjustment amount includes a power adjustment amount of the inner heater and a power adjustment amount of the outer heater.

In some embodiments, the processor determines the power adjustment amount based on the current heating power, the current temperature, and the target temperature through a second preset relationship table.

In some embodiments, the second preset relationship table may include a correspondence between the current heating power, the current temperature, the target temperature, and the power adjustment amount. In some embodiments, the second preset relationship table is determined based on current heating powers, current temperatures, target temperatures, and actual power adjustment amounts in the historical experimental data. The processor may adjust the current temperature of the glass liquid to the target temperature based on a power adjustment amount in the historical experimental data, and designate the power adjustment amount as the actual power adjustment amount.

In some embodiments, in the historical experimental data, the target temperature is acquired by the temperature sensor. The temperature sensor may be disposed within the feeding space 5.

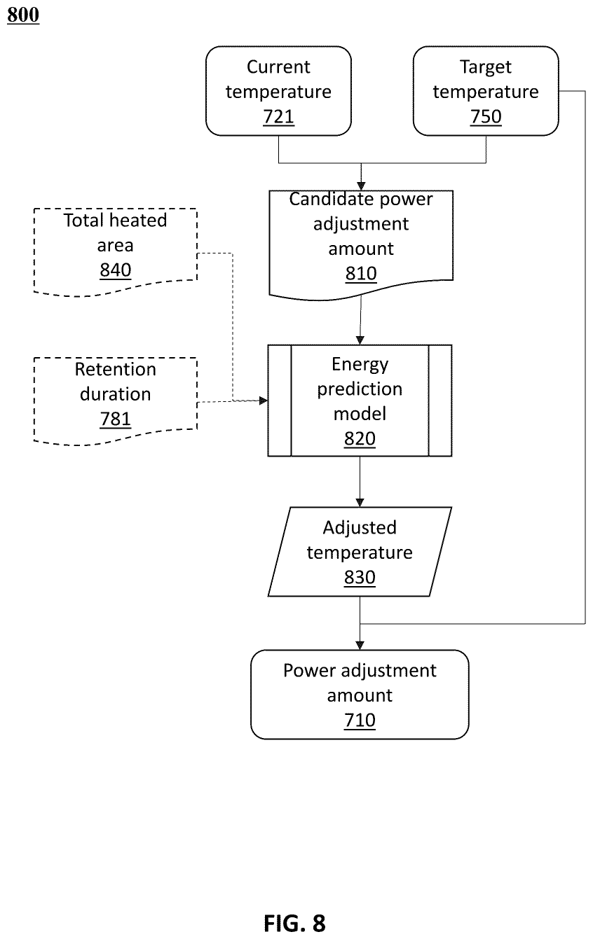

More information about determining the power adjustment amount can be found in FIG. 8 and its associated description.

In some embodiments, the current adjustment amount of the inner heater and the current adjustment amount of the outer heater are determined based on the power adjustment amount.

In some embodiments, the processor divides the power adjustment amount into two equal parts and distributes the two parts to the inner heater and the outer heater, respectively. Based on a current-to-power conversion rule, a corresponding current adjustment amount of the inner heater and a corresponding current adjustment amount of the outer heater are then determined.

The current-to-power conversion rule may be pre-set by a specialized technician based on priori experience.

In some embodiments, the current adjustment amount of the inner heater and the current adjustment amount of the outer heater are sent to control units of the inner heater and the outer heater, respectively.

The control unit is a device configured to receive parameters/instructions from the processor, so to control the currents of the inner heater and the outer heater. The control unit may be located in the inner heater and the outer heater.

In some embodiments of the present disclosure, the processor determines the target temperature based on the current temperature of the glass liquid and the change feature of the extraction amount. Based on the current heating power, the current temperature, and the target temperature, after determining the power adjustment amount, the current adjustment amount of the inner heater and the current adjustment amount of the outer heater may be accurately distributed and sent to the respective control unit in real-time, thereby ensuring a homogenized adjustment of the temperature of the glass liquid.

In some embodiments, the processor determines a first heated area based on an outer surface area of the feeding inner pipe. The processor determines a second heated area based on an inner surface area of the feeding outer pipe.

In some embodiments, the first heated area refers to a contact area between the glass liquid and the feeding inner pipe.

The outer surface area of the feeding inner pipe and the inner surface area of the feeding outer pipe may be determined based on dimensional parameters (e.g. a pipe diameter, a pipe length, etc.,) of the feeding inner pipe and the feeding outer pipe. In some embodiments, in response to determining that the feeding inner pipe is approximately a cylinder, the outer surface area of the feeding inner pipe is determined using a formula for determined a side surface area of the cylinder on which the outer side of the feeding inner pipe is located.

In some embodiments, the second heated area refers to a contact area between the glass liquid and the feeding outer pipe.

In some embodiments, in response to determining the feeding outer pipe being approximately a cylinder, the inner surface area of the feeding outer pipe is determined using a formula for determined a side surface area of the cylinder on which the inner side of the feeding outer pipe is located.

In some embodiments, the first heated area is equal to the outer surface area of the feeding inner pipe. The second heated area is equal to the inner surface area of the feeding outer pipe.

In some embodiments, the processor determines the current adjustment amount of the inner heater based on the first heated area and the power adjustment amount. For example, the processor determines a first ratio in a plurality of manners, and determine a first adjustment ratio based on the first ratio. The processor then determines, based on the first adjustment ratio, the current adjustment amount of the inner heater using the current-to-power conversion rule. For example, the first adjustment ratio being 40 w represents that a power of the inner heater needs to be increased by 40 w by adjusting the current of the inner heater. Therefore, the current adjustment amount of the inner heater may be determined based on the current-to-power conversion rule.

The first ratio is a proportionality coefficient used to determine the current adjustment amount of the inner heater.

In some embodiments, the processor may determine the first ratio in various ways. For example, the processor determines a sum of the first heated area and the second heated area, and then divides the first heated area by the sum as the first ratio. For example, the processor determines a sum of a square of the first heated area and a square of the second heated area, and then divides the square of the first heated area by the sum of the square of the first heated area and the square of the second heated area as the first ratio.

The first adjustment ratio is a value of a power adjustment amount that may be allocated to the inner heater.

In some embodiments, the processor designates a value obtained by multiplying the first ratio and the power adjustment amount as the first adjustment ratio.

In some embodiments, the processor determines the current adjustment amount of the outer heater based on the second heated area and the power adjustment amount. For example, the processor determines a second ratio and determines a second adjustment ratio based on the second ratio. The processor then determines the current adjustment amount of the outer heater based on the second adjustment ratio using the current-to-power conversion rule. As an example only, the second adjustment ratio being 40 w represents that a power of the outer heater needs to be increased by 40 w by regulating a current of the outer heater. Thus, the current adjustment amount of the outer heater may be determined based on the current-to-power conversion rule.

The second ratio is a proportionality coefficient used to determine the current adjustment amount of the outer heater.

In some embodiments, the processor may determine the second ratio in various ways. For example, the processor determines the sum of the first heated area and the second heated area, and then divides the second heated area by the sum as the second ratio. As another example, the processor determines a sum of a square of the first heated area and a square of the second heated area, and then divides the square of the second heated area by the sum of the square of the first heated area and the square of the second heated area as the second ratio.

The second adjustment ratio is a value of a power adjustment amount that may be allocated to the outer heater.

In some embodiments, the processor designates a value obtained by multiplying the second ratio and the power adjustment amount as the second adjustment ratio.

In some embodiments of the present disclosure, the current adjustment amount of the inner heater and the current adjustment amount of the outer heater are determined, respectively, based on a relationship between the first heated area and the power adjustment amount and a relationship between the second heated area and the power adjustment amount. In this way, the power adjustment amount can be precisely distributed according to an actual demand, which in turn improves the accuracy of adjusting the current adjustment amount of the inner heater and the current adjustment amount of the outer heater, and is conducive to a homogenization of the temperature of the glass liquid, thereby ensuring more efficient and accurate heating control.

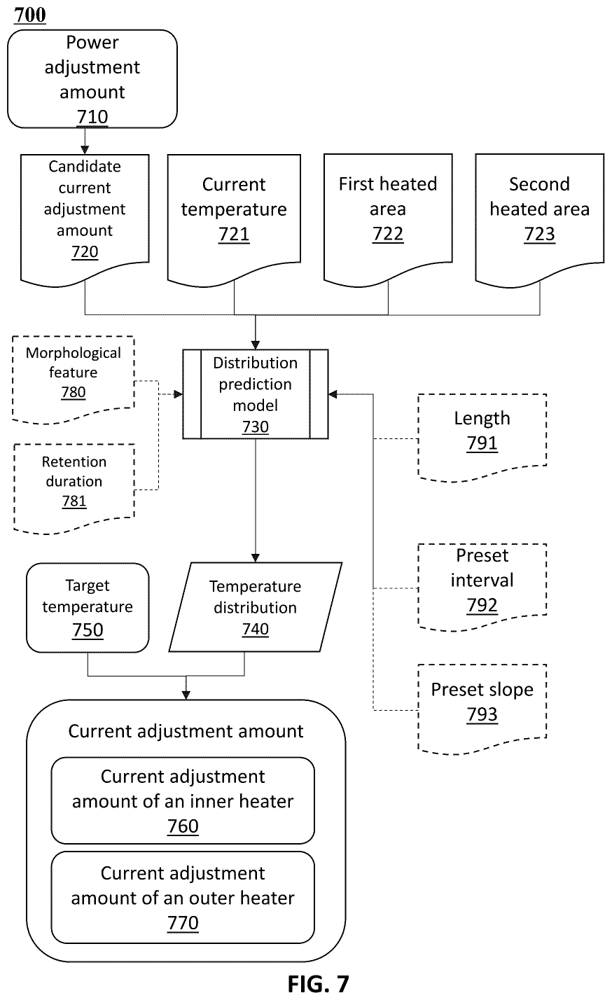

More information about the current adjustment amount of the inner heater, and the current adjustment amount of the outer heater can be found in FIG. 7 and its related descriptions thereof.

Operation 620, in response to receiving the instruction from the molding process to decrease the extraction amount, the currents of the inner heater and the outer heater are decreased. The temperature of the glass liquid is controlled to be decreased by decreasing the currents.

In some embodiments, in order to adapt a decreased extraction amount and to avoid excessive temperatures that would cause the glass liquid to overflow or be damaged, the processor decreases a heating amount by decreasing the currents of the inner heater and the outer heater, thereby decreasing the temperature of the glass liquid.

Operation 630, in response to receiving the instruction from the molding process to increase the extraction amount, the currents of the inner heater and the outer heater are increased. The temperature of the glass liquid is controlled to be increased by increasing the currents.

In some embodiments, in order to adapt an increased extraction amount and ensure sufficient flow of the glass liquid for the molding process, the processor increases the heating amount by increasing the currents of the inner heater and the outer heater, thereby increasing the temperature of the glass liquid.

In some embodiments, when the glass liquid enters a feeding device via a feeding inlet, if the temperature of the glass liquid is less than or greater than a required feeding temperature for molding, it is necessary to warm up or cool down the glass liquid (e.g., heating both the inside and the outside of the glass liquid at the same time by adjusting the currents of the inner heater and the outer heater differentially), which ensures the homogenization of the temperature of the glass liquid after warming up or cooling down the glass liquid.

In some embodiments of the present disclosure, the glass liquid enters the feeding device via the feeding inlet, and when the molding process issues the instruction to reduce or increase the extraction amount, the extraction amount is controlled by increasing or decreasing the temperature of the glass liquid using the feeding device (e.g., by adjusting the currents of the inner heater and the outer heater, temperatures of the glass liquid and outside the glass liquid can be increased or decreased uniformly), which shortens a reaction time to adjust the extraction amount and realizes a precise control of the extraction amount.

FIG. 7 is a schematic diagram illustrating a distribution prediction model according to some embodiments of the present disclosure.

In some embodiments, a processor generates a candidate current adjustment amount 720 based on a power adjustment amount 710, as shown in FIG. 7. The processor predicts a temperature distribution 740 corresponding to the candidate current adjustment amount 720 based on the candidate current adjustment amount 720, a current temperature 721, a first heated area 722, and a second heated area 723 using a distribution prediction model 730.

The candidate current adjustment amount 720 is an alternative data that may be used as a current adjustment amount. In some embodiments, the candidate current adjustment amount 720 includes a candidate current adjustment amount of an inner heater and a candidate current adjustment amount of an outer heater.

In some embodiments, the processor randomly generates a plurality of sets of allocation rules for power adjustment amount based on the power adjustment amount 710, and then determines, based on a current-to-power conversion rule, a plurality of candidate current adjustment amounts 720 corresponding to each of the sets of allocation rules, thereby generating a plurality of candidate current adjustment amounts.

The allocation rule is a rule configured to divide the power adjustment amount of the inner heater and the outer heater. The allocation rule may be obtained by preset.

In some embodiments, the distribution prediction model 730 may be a Deep Neural Networks (DNN) model, etc.

The temperature distribution 740 is a distribution value of an adjusted temperature corresponding to the candidate current adjustment amount. In some embodiments, the temperature distribution 740 includes adjusted temperatures at a plurality of points.

In some embodiments, in historical production or historical experiments, to obtain accurate temperature data of glass liquid, a plurality of points are preset, and temperature sensors are deployed within a device for controlling an extraction amount and homogenizing glass liquid to collect data. A first sample and a first label are constructed based on the data using the distribution prediction model. However, in current production, only one temperature sensor is required to obtain an actual average temperature value (e.g., a current temperature) of the glass liquid. The processor predicts a temperature distribution at the plurality of points based on the current temperature of the glass liquid. That is, the current temperature is a single temperature value, while the temperature distribution is a temperature distribution predicted at the plurality of points.

A point of the plurality of points is where a sensor (e.g., a temperature sensor) is deployed in a device for controlling an extraction amount and homogenizing glass liquid during historical production or historical experiments. The plurality of points may be pre-set.

In some embodiments, the distribution prediction model 730 is obtained by training a large number of first training samples each of which includes a first label. The processor may input each of the plurality of first training samples with a first label into an initial distribution prediction model, construct a loss function based on the first label and a result of the initial distribution prediction model, and iteratively update the initial distribution prediction model based on the loss function. A training process is completed when a preset condition is met, and a trained distribution prediction model is obtained. The preset condition may be that the loss function converges, a count of iterations is greater than a threshold, or the like.

In some embodiments, each first training sample for training the distribution prediction model 730 is a sample current adjustment amount from historical sample data, a sample current temperature of sample glass liquid, and a sample first heated area between the sample glass liquid and a sample feeding inner pipe, and a sample second heated area between the sample glass liquid with a sample feeding outer pipe. A first label may be an actual temperature distribution corresponding to a sample current temperature after adjusting the sample current temperature based on the sample current adjustment amount, the sample first heated area, and the sample second heated area in historical sample data. The actual temperature distribution may be acquired by a plurality of temperature sensors in the historical experiments.

In some embodiments, inputs to the distribution prediction model 730 also include a morphological feature 780 and a retention duration 781 of the glass liquid within a feeding space.

Correspondingly, each first training sample further includes a sample morphological feature of the sample glass liquid within a sample feeding space and a sample retention duration of the sample glass liquid.

The morphological feature 780 is a morphology of the glass liquid within the feeding space.

In some embodiments, the morphology of the glass liquid within the feeding space may be viewed as composed of a plurality of rings stacked up and down, with each ring consisting of two concentric circles. That is, the morphological feature of the glass liquid within the feeding space may include a ring width of a ring corresponding to each cross-section of a plurality of cross-sections. The plurality of cross-sections are obtained by dividing the feeding space at a preset interval. The ring width is a difference between radii of two concentric circles that form the ring.

The retention duration is a time elapsed from a time point when the glass liquid flows into a heating channel to a time point when the glass liquid outflows from the heating channel.

In some embodiments, the processor designates a value obtained by dividing a longitudinal length of the feeding space by an average flow rate of the glass liquid within the feeding space as the retention duration. The average flow rate of the glass liquid may be characterized in terms of a flow amount or a flow rate of the glass liquid at an injection time of the glass liquid.

The longitudinal length of the feeding space may be obtained by actual measurement with a measuring tape.

The average flow rate of the glass liquid within the feeding space is a flow amount or a flow rate of the glass liquid at the injection time.

In some embodiments of the present disclosure, the morphological feature may affect a heat transfer between parts of the glass liquid, and the retention duration in the heating channel may affect a time period during which the glass liquid is heated, and both the morphological feature and the retention duration have an effect on the temperature distribution. Therefore, introducing the morphological feature and the retention duration is conducive to improving the accuracy of predicting the temperature distribution.

In some embodiments, the inputs to the distribution prediction model 730 also include a length 791, a preset interval 792, and a preset slope 793 of a downward-sloping bump.

Correspondingly, the first training sample may also include a sample length, a sample preset interval, and a sample preset slope of a sample downward-sloping bump.

In some embodiments of the present disclosure, the downward-sloping bump enables glass liquid to mix while flowing downwardly, and thus a specific dimension of the downward-sloping bump also affects a heat transfer of the glass liquid. By introducing a length, a preset interval, and a preset slope of a downward-sloping bump, it is conducive to improving the accuracy of predicting the temperature distribution.

In some embodiments, the processor determines a current adjustment amount 760 of the inner heater and a current adjustment amount 770 of the outer heater based on the temperature distribution 740 and a target temperature 750. For example, the processor determines temperature homogenization degrees and temperature differences corresponding to a plurality of sets of candidate current adjustment amounts, then determines a weighted value corresponding to each set of candidate current adjustment amounts, and finally selects an optimal candidate current adjustment amount (e.g., a set of candidate current adjustment amount with the largest weighted value), and designates a candidate current adjustment amount of an inner heater and a candidate current adjustment amount of an outer heater in the set of candidate current adjustment amount as the current adjustment amount of the inner heater and the current adjustment amount of the outer heater, respectively.

In some embodiments, the processor designates an inverse of a variance of each temperature value in the temperature distribution corresponding to the candidate current adjustment amount as a temperature homogenization degree.

In some embodiments, the processor designates an absolute value of a difference between an average value of each temperature value in the temperature distribution corresponding to the candidate current adjustment amount and a target temperature as the temperature difference.

In some embodiments, the processor determines the weighted value based on a relationship in which the weighted value is positively correlated to the temperature homogenization degree and negatively correlated to the temperature difference using a following formula (1).

K=a×T₁−b×T₂ (1),

where K denotes the weighted value corresponding to the candidate current adjustment, T₁ denotes the temperature homogenization degree, T₂ denotes the temperature difference, and a and b denote weighting coefficients and may be obtained through preset.

In some embodiments of the present disclosure, by randomly generating the plurality of sets of candidate current adjustment amounts and combining the current temperature, the first heated area, and the second heated area, and predicting the temperature distribution after an adjustment using the distribution prediction model, the accuracy and uniformity of temperature control are improved. In addition, the optimal current adjustment amount is selected by calculating a weighted value of the temperature homogenization degree and the temperature difference, which not only ensures the heating efficiency, but also optimizes a homogenization of the temperature distribution.

FIG. 8 is a schematic diagram illustrating an energy prediction model according to some embodiments of the present disclosure.

In some embodiments, a processor determines a candidate power adjustment amount 810 based on the current temperature 721 and the target temperature 750 as shown in FIG. 8. The processor determines an adjusted temperature 830 corresponding to the candidate power adjustment amount 810 based on the candidate power adjustment amount 810 and the current temperature 721 using an energy prediction model 820.

The candidate power adjustment amount 810 is an alternative value that may be used as a power adjustment amount.

In some embodiments, the processor determines the candidate power adjustment amount in various manners. For example, in response to determining a target temperature being greater than or equal to a current temperature, the processor randomly generates a plurality of power increase amounts as a plurality of candidate power adjustment amounts. The power increase amount may be determined based on a priori experience.

The adjusted temperature 830 is a temperature (e.g., an average of a temperature of a glass liquid) after a current temperature of the glass liquid has been adjusted using the energy prediction model 820.

In some embodiments, the energy prediction model 820 is a Deep Neural Networks (DNN) model.

In some embodiments, the energy prediction model 820 may be obtained based on a large number of second training samples each of which includes a second label. Each second training sample for training the energy prediction model may be a sample power adjustment amount and a sample current temperature of sample glass liquid in historical experimental data.

Each second label may be a corresponding adjusted temperature after a sample current temperature of a sample glass liquid has been adjusted based on a sample power adjustment amount in historical experimental data. An actually adjusted temperature may be acquired by a temperature sensor, which may be deployed in a feeding space in historical experiments.

In some embodiments, a training of the energy prediction model 820 is similar to a training of the distribution prediction model 730, as can be seen in FIG. 7 and its related descriptions, and will not be repeated here.

In some embodiments, inputs to the energy prediction model 820 also include a total heated area 840 and a retention duration 781.

Correspondingly, the second training sample may also include a sample total heated area and a sample retention duration.

The total heated area is a sum of the first heated area and the second heated area.

In some embodiments of the present disclosure, the total heated area may affect an area of the glass liquid that receives heating, and the retention duration in a heating channel may affect a time period during which the glass liquid is heated, so both the total heated area and the retention duration have an important effect on a final temperature of the glass liquid. Therefore, introducing the total heated area and the retention duration is conducive to improving the accuracy of the energy prediction model.

In some embodiments, the processor determines the power adjustment amount 710 based on the adjusted temperature 830 and the target temperature 750. For example, the processor selects a candidate power adjustment amount corresponding to an adjusted temperature that is closest to the target temperature as the power adjustment amount.

In some embodiments of the present disclosure, predicting the adjusted temperature using the energy prediction model may effectively simulate different heating scenarios, ensure the accuracy and truthfulness of the adjusted temperature, and further improve the accuracy in determining the power adjustment amount subsequently. In addition, by selecting the candidate power adjustment amount corresponding to the adjusted temperature that is closest to the target temperature, problems such as over-heating or under-heating can be avoided, which improves the stability of the entire production process.

It is known from common sense of the art that the present invention can be realized by other embodiments which are not divorced from its spiritual essence or necessary features. Thus, the embodiments disclosed above are, in all respects, illustrative and not exclusive, and all changes within the scope of the present invention, or within the scope of an equivalent invention, are encompassed by the present invention.

The basic concepts have been described above, and it is apparent to those skilled in the art that the foregoing detailed disclosure is intended as an example only and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments of the present disclosure. Such as “an embodiment,” “one embodiment,” and/or “some embodiments” means a feature, structure, or characteristic associated with at least one embodiment of the present disclosure. Accordingly, it should be emphasized and noted that “an embodiment” or “one embodiment” or “an alternative embodiment” in different places in the present disclosure do not necessarily refer to the same embodiment. In addition, certain features, structures, or characteristics of one or more embodiments of the present disclosure may be suitably combined.

Additionally, the order in which the elements and sequences are processed in the present disclosure, the use of numerical letters, or the use of other names is not intended to qualify the order of the processes and methods of the present disclosure, unless expressly stated in the claims. While some embodiments of the invention that are currently considered useful are discussed in the foregoing disclosure by way of various examples, it should be appreciated that such details serve only illustrative purposes, and that additional claims are not limited to the disclosed embodiments, rather, the claims are intended to cover all amendments and equivalent combinations that are consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be noted that in order to simplify the presentation of the present disclosure, and thereby aid in the understanding of one or more embodiments of the invention, the foregoing descriptions of embodiments of the present disclosure sometimes set multiple features together in a single embodiment, accompanying drawings, or a description thereof. However, this method of disclosure does not imply that the objects of the present disclosure require more features than those mentioned in the claims. Rather, claimed subject matter may lie in less than all features of a single foregoing disclosed embodiment.

Some embodiments use numbers to describe the number of components and attributes, and it should be understood that such numbers used in the description of the embodiments are modified in some examples by the modifiers “about,” “approximately,” or “substantially”. Unless otherwise noted, the terms “about,” “approximately,” or “substantially” indicate that a ±20% variation in numbers is allowed. Correspondingly, in some embodiments, the numerical parameters used in the present disclosure and claims are approximations, which can change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present disclosure are approximations, in specific embodiments, such values are set to be as precise as possible within a feasible range.

For each of the patents, patent applications, patent application disclosures, and other materials cited in the present disclosure, such as articles, books, specification sheets, publications, documents, etc., the entire contents of which are hereby incorporated herein by reference. Application history documents that are inconsistent with or conflict with the contents of the present disclosure are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and the contents of the present disclosure, the descriptions, definitions, and/or use of terms in the present disclosure shall prevail.

Finally, it should be understood that the embodiments in the present disclosure are only used to illustrate the principles of the embodiments in the present disclosure. Other deformations may also fall within the scope of the present disclosure. As such, alternative configurations of embodiments of the present disclosure may be considered to be consistent with the teachings of the present disclosure as an example, not as a limitation. Correspondingly, the embodiments of the present disclosure are not limited to the embodiments expressly presented and described herein.

What is claimed is:

1. A device for controlling an extraction amount and homogenizing glass liquid, comprising a feeding device and an auxiliary heating device, wherein
the feeding device includes a feeding inner pipe and a feeding outer pipe,
the feeding inner pipe is provided inside the feeding outer pipe,
the feeding outer pipe includes a feeding upper outer pipe, a feeding middle outer pipe, a feeding lower outer pipe, and a tapered pipe,
the feeding upper outer pipe is mounted on an upper end of the feeding middle outer pipe,
the feeding lower outer pipe is mounted on a lower end of the feeding middle outer pipe,
the feeding upper outer pipe, the feeding middle outer pipe, and the feeding lower outer pipe are connected through the tapered pipe,
the auxiliary heating device includes an inner heater and an outer heater,
the inner heater is disposed inside the feeding inner pipe and is installed by fitting with the feeding inner pipe, and
the outer heater wraps the feeding outer pipe and is installed by fitting with the feeding outer pipe.

2. The device of claim 1, wherein each of the feeding upper outer pipe, the feeding middle outer pipe, and the feeding lower outer pipe is a circular straight pipe with a shape of a hollow cylinder, and a shape of the tapered pipe is a hollow frustum of a cone.

3. The device of claim 2, wherein a cross-sectional diameter of the feeding middle outer pipe is larger than a cross-sectional diameter of the feeding lower outer pipe, and the cross-sectional diameter of the feeding lower outer pipe is greater than a cross-sectional diameter of the feeding upper outer pipe.

4. The device of claim 3, wherein a length of the feeding middle outer pipe is greater than a length of the feeding lower outer pipe, and the length of the feeding lower outer pipe is greater than a length of the feeding upper outer pipe.

5. The device of claim 1, wherein the feeding inner pipe includes a circular straight pipe and a conical pipe, and the conical pipe is mounted at an end of the circular straight pipe of the feeding inner pipe.

6. The device of claim 1, wherein the feeding inner pipe and the feeding outer pipe are made of platinum-rhodium alloy.

7. The device of claim 6, wherein the outer heater is wrapped with a thermal insulation material outside.

8. The device of claim 7, wherein the insulation material, the inner heater, and the outer heater are made of aluminum oxide.

9. The device of claim 1, wherein the inner heater is cylindrical-shaped.

10. The device of claim 9, wherein the inner heater and the outer heater are embedded with a pure platinum wire inside.

11. The device of claim 10, wherein a diameter of the pure platinum wire is within a range of 2.5 mm to 3.0 mm.

12. The device of claim 1, wherein an inner filling gap is formed between the inner heater and the feeding inner pipe, an outer filling gap is formed between the outer heater and the feeding outer pipe, and a feeding space is formed between the feed inner pipe and the feed outer pipe.

13. The device of claim 12, wherein a width of the inner filling gap and a width of the outer filling gap are within a range of 10 mm to 20 mm.

14. The device of claim 12, wherein filling materials of the inner filling gap and the outer filling gap are alumina powder.

15. The device of claim 12, wherein a length of the feeding inner pipe is less than a length of the feeding outer pipe.

16. The device of claim 1, wherein a plurality of downward-sloping bumps are arranged in a staggering manner on an outer side of the feeding inner pipe and on an inner side of the feeding outer pipe.

17. A method for controlling an extraction amount and homogenizing glass liquid, comprising:
in response to receiving an instruction from a molding process to decrease or increase an extraction amount, adjusting currents of an inner heater and an outer heater, and controlling a temperature of the glass liquid according to the currents;
in response to receiving the instruction from the molding process to decrease the extraction amount, decreasing the currents of the inner heater and the outer heater, wherein the temperature of the glass liquid is controlled to be decreased by decreasing the currents; and
in response to receiving the instruction from the molding process to increase the extraction amount, increasing the currents of the inner heater and the outer heater, wherein the temperature of the glass liquid is controlled to be increased by increasing the currents.

18. The method of claim 17, further comprising:
in response to determining that a change amount of the extraction amount of the glass liquid in a preset interval satisfies a current adjustment condition:
determining a target temperature of the glass liquid based on a current temperature of the glass liquid and a change feature of the glass liquid of the molding process;
determining a power adjustment amount based on a current heating power, the current temperature, and the target temperature;
determining, based on the power adjustment amount, a current adjustment amount of the inner heater and a current adjustment amount of the outer heater; and
sending the current adjustment amount of the inner heater and the current adjustment amount of the outer heater to a control unit of the inner heater and the outer heater, respectively, wherein the current adjustment condition includes that the change amount of the extraction amount of the glass liquid in the preset interval is greater than a preset threshold.

19. The method of claim 18, wherein the determining, based on the power adjustment amount, a current adjustment amount of the inner heater and a current adjustment amount of the outer heater includes:
determining a first heated area based on an outer surface area of the feeding inner pipe and a second heated area based on an inner surface area of the feeding outer pipe, wherein the first heated area refers to a contact area between the glass liquid and the feeding inner pipe, and the second heated area refers to a contact area between the glass liquid and the feeding outer pipe;
determining the current adjustment amount of the inner heater based on the first heated area and the power adjustment amount; and
determining the current adjustment amount of the outer heater based on the second heated area and the power adjustment amount.

20. The method of claim 18, wherein the determining a power adjustment amount based on a current heating power, the current temperature, and the target temperature includes:
determining a candidate power adjustment amount based on the current temperature and the target temperature;
predicting, using an energy prediction model, an adjusted temperature corresponding to the candidate power adjustment amount based on the candidate power adjustment amount and the current temperature; and
determining the power adjustment amount based on the adjusted temperature and the target temperature.
